(19) United States
(12) Patent Application Publication
(10) Pub. No.: US 2025/0132716 A1
(43) Pub. Date: Apr. 24, 2025

(54) Rotatable Angle Bracket for Fixed Tilt Photovoltaic Module Racking Systems

(71) Applicant: BCI Steel, LLC, Leetsdale, PA (US)

(72) Inventors: Tim Jaki, Canonsburg, PA (US); Benjamin Peterson, Conway, PA (US); Rutheren Moorthi, Sewickley, PA (US); Adam Junstrom, Pittsburgh, PA (US); Rachel Sheridan, Coraopolis, PA (US)

(21) Appl. No.: 18/883,670

(22) Filed: Sep. 12, 2024

Related U.S. Application Data
(60) Provisional application No. 63/537,951, filed on Sep. 12, 2023.

(51) Int. Cl. H02S 20/30

(52) U.S. Cl. CPC H02S 20/30

(57) ABSTRACT

A rotatable angle bracket for connecting a fixed tilt photovoltaic module racking system, having: a top surface, the top surface having at least one elongated aperture and a bent tab, the bent tab connected to the top surface at an angle; and a side surface connected to the top surface at an angle, the side surface having at least one elongated angled aperture aligned with at least one aperture forming an axis, a side of the side surface and the axis are aligned parallel; the at least one elongated angled aperture has a first end and a second end and the bent tab extends past the side surface.

### CROSS-REFERENCE TO RELATED APPLICATIONS

The present application claims priority to and the benefit of U.S. Provisional Application No. 63/537,951 filed Sep. 12, 2023, entitled “Rotatable Angle Bracket for Fixed Tilt Photovoltaic Module Racking Systems” the disclosures of which are hereby incorporated by reference in their entirety.

### BACKGROUND OF THE INVENTION

### Field of the Invention

The present invention relates to an angle bracket for connecting a rafter to a beam in a module racking system. This angle bracket is able to rotate and is capable of adjusting such that the bracket and beam are rotated during installation of the racking system with photovoltaic modules.

### Description of Related Art

Solar energy is a growing and viable solution to meet the increasing demand for energy. The use of solar cells or photovoltaic cells is one method of harnessing the sun's energy for residential or commercial applications. In solar energy systems, efficiency is an important aspect of the useful energy output of the system. The racking systems must be installed correctly and efficiently to orient a photovoltaic module in the direction of maximum exposure to the sun's energy throughout the day. This orientation control can increase the energy output throughout a day over a fixed orientation solar energy device.

The current commercially available racking designs require that long, C shape beams of the racking structure be unloaded onto the ground and then manually lifted into place for fastening to other structural members. This installation method equates to significant manual labor effort to fasten the beams in place.

The current, fixed position of existing designs of angle brackets requires that beams be lifted and then held in place when mounting. All options require the beams to be lifted, which include installers having to lay on their backs on the ground, or crouch down to an uncomfortable position to make the lowest connections on their backside. Working from an uncomfortable position all day long results in worker fatigue and dissatisfaction. Further, raising the arrangement higher above the ground requires significant strength all day long which also leads to worker fatigue and dissatisfaction. Finally, the connection could be made from the top side using a “top-down” clamp, but use of a top-down clamp results in significant cost increases especially for large utility scale projects.

In light of the above-mentioned problems, there is a need for a solar racking system that is efficiently installed to reduce the amount of installation time and effort.

The invention leverages the concept of U.S. patent application Ser. No. 17/665,833 filed Feb. 7, 2022, entitled “Tilting Arrangement for a Photovoltaic Module Rack”. The “tilting” capability described in the Ser. No. 17/665,833 application enables utilization of the Rotatable Angle Bracket and installation of the racking system beams in a specific manner using the Rotatable Angle Bracket.

### SUMMARY OF THE INVENTION

In one embodiment, a rotatable angle bracket for connecting a fixed tilt photovoltaic module racking system, includes a top surface, the top surface having at least one elongated aperture and a bent tab, the bent tab connected to the top surface at an angle; and a side surface connected to the top surface at an angle, the side surface having at least one elongated angled aperture aligned with at least one aperture forming an axis, a side of the side surface and the axis are aligned parallel; where the at least one elongated angled aperture has a first end and a second end and the bent tab extends past the side surface.

In another embodiment, the angle the bent tab is coupled to the top surface at is approximately 90 degrees.

In another embodiment, the angle the top surface is coupled to the side surface is at approximately 90 degrees.

In another embodiment, the top surface further includes a second elongated aperture.

In another embodiment, the side surface further includes at least two apertures.

In another embodiment, the side surface further includes at least one notch.

In another embodiment, a photovoltaic module racking system, includes: a base member, the base member having a first end and a second end; a rafter coupled to the first end of the base member, the rafter having a first end and a second end and a front surface and a side surface, the first end or second end having at least two apertures; and a rotatable angle bracket coupled to the first end or second end of the rafter, the rotatable angle bracket includes: a top surface, the top surface having at least one elongated aperture and a bent tab, the bent tab connected to the top surface at an angle; a side surface connected to the top surface at an angle, the side surface having at least one elongated angled aperture aligned with at least one aperture forming an axis, a side of the side surface and the axis are aligned parallel, the at least one elongated angled aperture has a first end and a second end and the bent tab extends past the side surface; where in a first state, the at least two apertures of the rafter and the axis are not aligned parallel, wherein in a second state, the at least two apertures of the rafter and the axis are aligned parallel.

In another embodiment, the base member is a H-shape geometry, a C-shaped geometry, a W-shaped geometry, a round-shaped geometry, a square-shaped geometry, or a rectangular-shaped geometry.

In another embodiment, the base member and rafter are coupled with an attachment bracket.

In another embodiment, the rafter is coupled to the base member at or near a center of gravity of the rafter.

In another embodiment, the at least one elongated angled aperture of the rotatable angle bracket and at least one aperture of the rafter are aligned and coupled by a bolt such that the rotatable angle bracket rotates about the bolt.

In another embodiment, in the first state the top surface of the rotatable angle bracket and a top side of the rafter are aligned parallel.

In another embodiment, in the second state the top surface of the rotatable angle bracket and a top side of the rafter are aligned perpendicular.

In another embodiment, in the first state the first end of the at least one elongated angled aperture is aligned parallel with the at least two apertures of the rafter and in a second state the second end of the at least one elongated angled aperture is aligned parallel with the at least two apertures of the rafter.

In another embodiment, a method of installing a system for a photovoltaic module, the method includes: coupling a rotatable angle bracket to a rafter in a first state; the rotatable angle bracket includes: a top surface, the top surface having at least one elongated aperture and a bent tab, the bent tab connected to the top surface at an angle; a side surface connected to the top surface at an angle, the side surface having at least one elongated angled aperture aligned with at least one aperture forming an axis, a side of the side surface and the axis are aligned parallel; where the at least one elongated angled aperture has a first end and a second end and the bent tab extends past the side surface; the rafter coupled to the first end of the base member, the rafter having a first end and a second end and a front surface and a side surface, the first end or second end having at least two apertures; coupling a beam to the rotatable angle bracket, the beam includes at least one aperture; and rotating the rotatable angle bracket from the first state to a second state, wherein in the first state, the at least two apertures of the rafter and the axis are not aligned parallel, wherein in the second state, the at least two apertures of the rafter and the axis are aligned parallel.

In another embodiment, sliding the rotatable angle bracket with the coupled beam from the first state.

In another embodiment, fixing the rotatable angle bracket to the coupled beam in the second state.

In another embodiment, contacting a first side of the beam with the bent tab.

In another embodiment, inserting a bolt in the aperture of the rafter to prevent the rotatable angle bracket from entering the second state.

In another embodiment, further includes removing the bolt.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

Other features, advantages, and details of the present invention will emerge on reading the following description of several embodiments of the invention given by way of illustration and not being limiting, said description being made with reference to the appended drawings.

FIG. 1 is a first side view of a rafter and a pile connected with an angle bracket fixed to the end of the rafter;

FIG. 2 is a second side view of the rafter and pile connected with an angle bracket fixed to the end of the rafter;

FIG. 3 is an end view of the angle bracket;

FIG. 4 is an isometric view of the angle bracket;

FIG. 5 is another isometric view of the angle bracket;

FIG. 6 is a top view of the angle bracket;

FIG. 7 is another isometric view of the angle bracket;

FIGS. 8A and 8B are a front and back view of the angle bracket, respectively;

FIG. 9A is a top view of an angle bracket;

FIG. 9B is a side view of the angle bracket of FIG. 9A;

FIG. 9C is a perspective view of the angle bracket of FIG. 9A;

FIG. 9D is a side view of the angle bracket of FIG. 9A;

FIG. 9E is a side view of the angle bracket of FIG. 9A;

FIG. 9F is a side view of the angle bracket of FIG. 9A;

FIG. 10 is a side view of the angle bracket attached in an initial position to the rafter;

FIG. 11 is a side view of the angle bracket attached in an initial position to the rafter with a beam;

FIG. 12 is a side view of the angle bracket attached in a horizontally slide position to the rafter with a beam;

FIG. 13 is a side view of the angle bracket attached in a fully horizontally slide position to the rafter with a beam;

FIG. 14 is a side view of the angle bracket attached in a vertically slide position to the rafter with a beam;

FIG. 15 is a side view of the angle bracket attached in a partially rotated position to the rafter with a beam;

FIG. 16 is a side view of the angle bracket attached in a further partially rotated position to the rafter with a beam;

FIG. 17 is a side view of the angle bracket attached in a vertical position to the rafter with a beam;

FIGS. 18a and 18b are a top view and an isometric view of the angle bracket attached to the rafter;

FIGS. 19a and 19b are a side view and another isometric view of the angle bracket attached to the rafter; and

FIG. 20 is a side isometric view of the angle bracket attached in a horizontal position to the rafter with a beam.

### DESCRIPTION OF THE INVENTION

For purposes of the description hereinafter, spatial orientation terms, as used, shall relate to the referenced embodiment as it is oriented in the accompanying drawings, figures, or otherwise described in the following detailed description. However, it is to be understood that the embodiments described hereinafter may assume many alternative variations and configurations. It is also to be understood that the specific components, devices, features, and operational sequences illustrated in the accompanying drawings, figures, or otherwise described herein are simply exemplary and should not be considered as limiting.

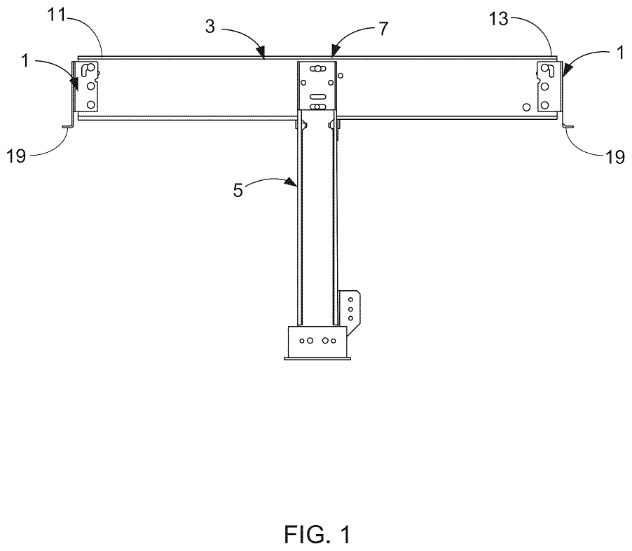

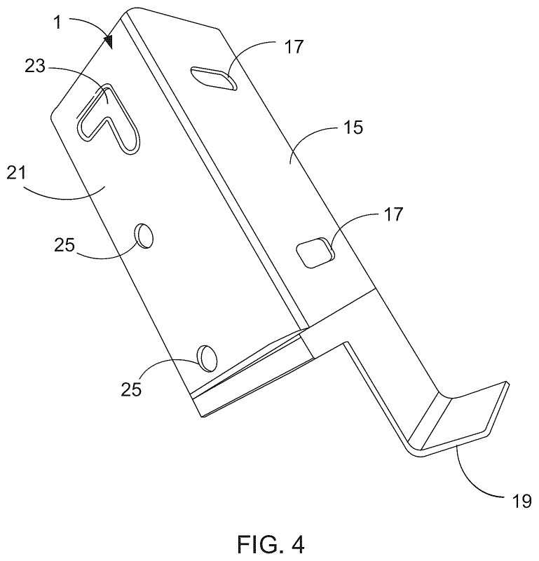

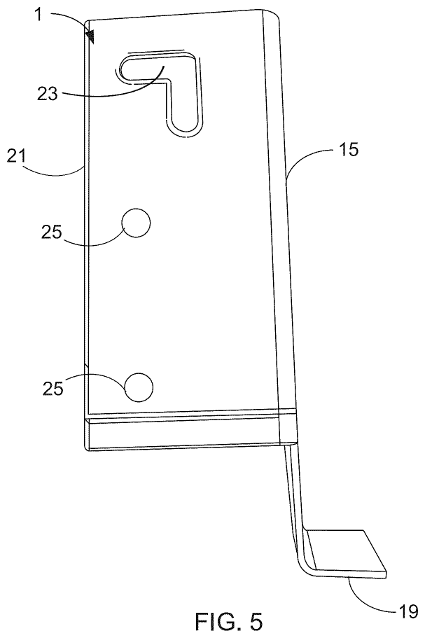

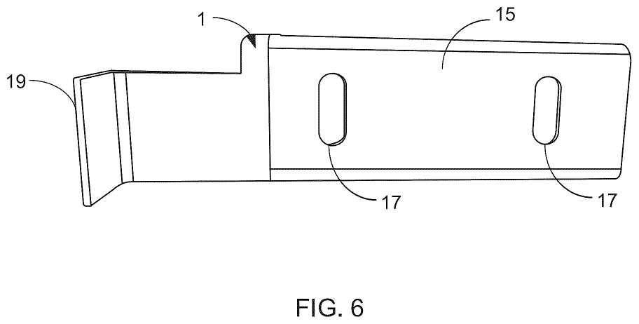

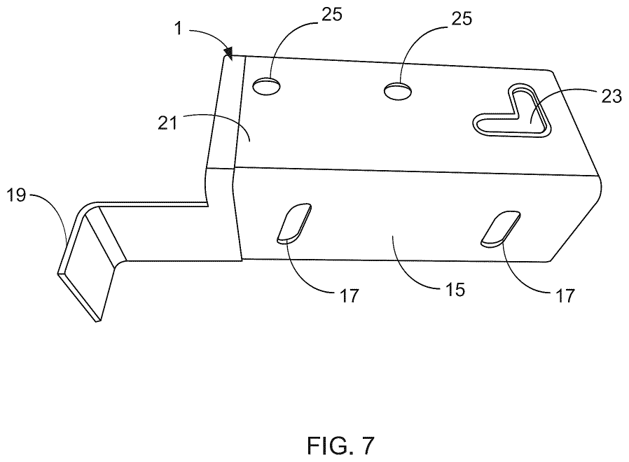

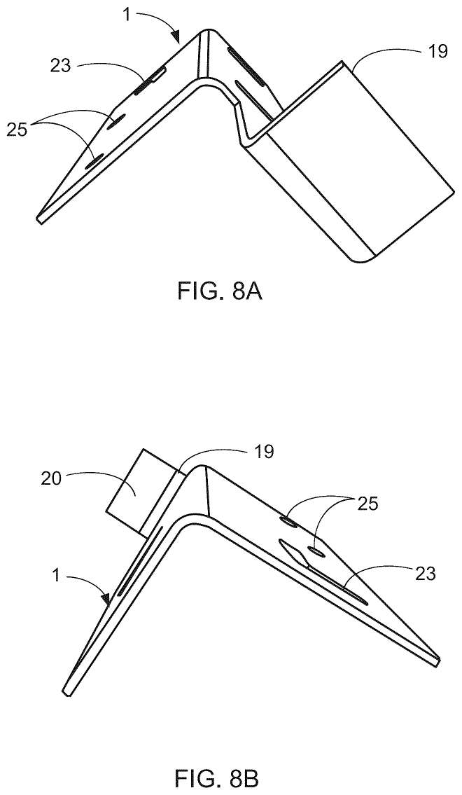

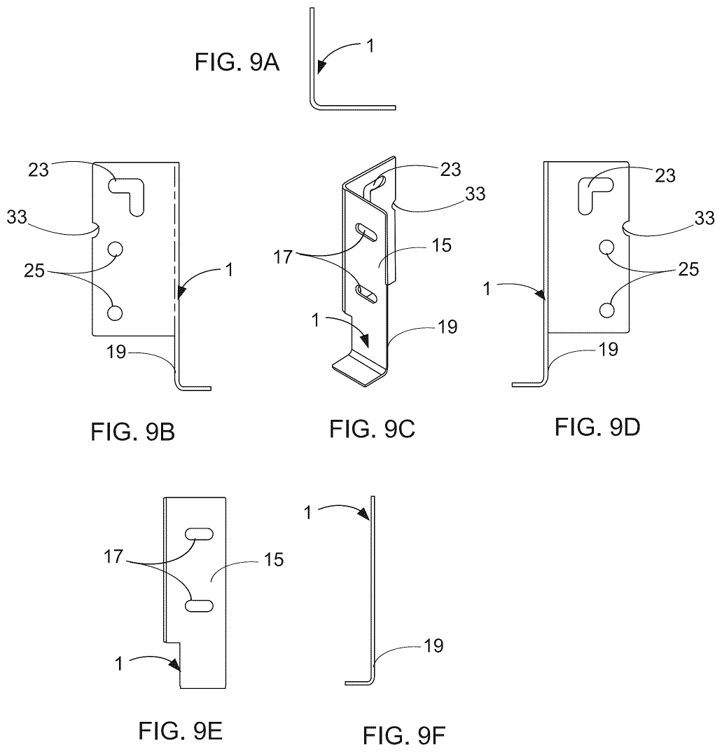

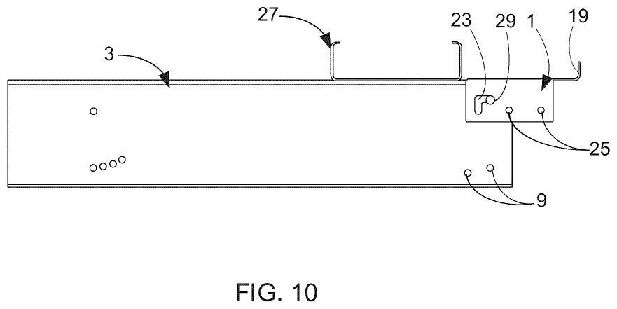

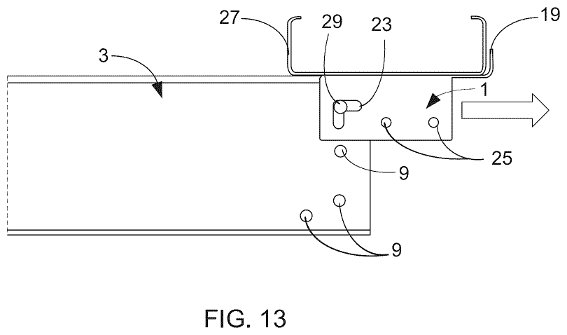

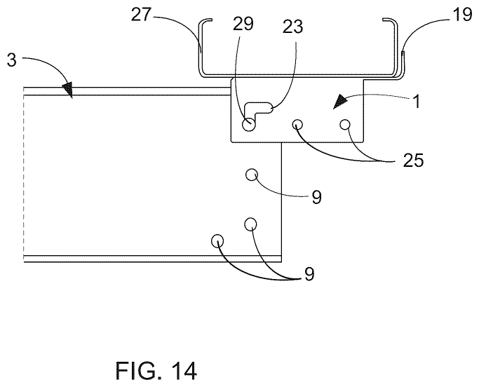

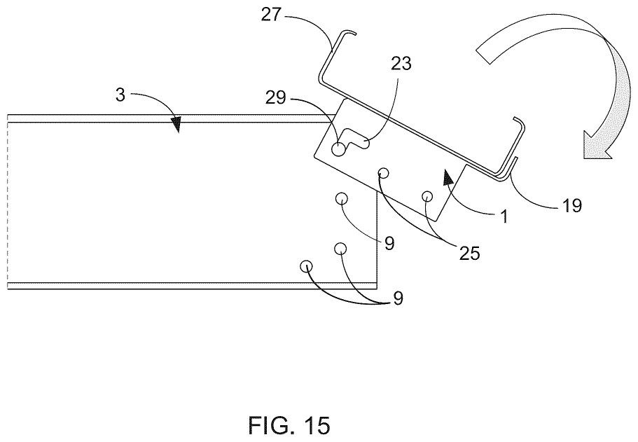

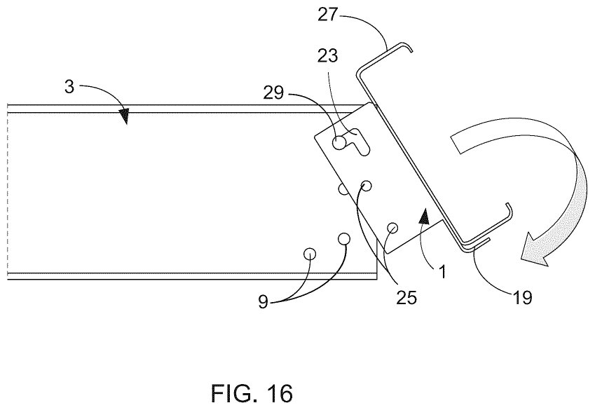

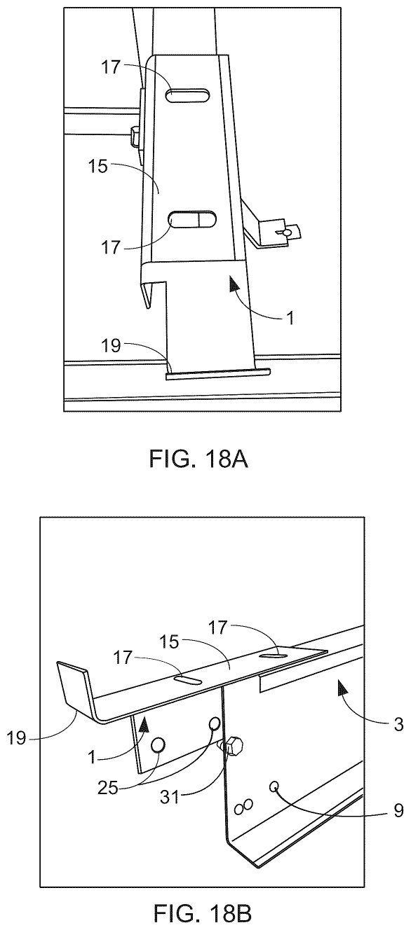

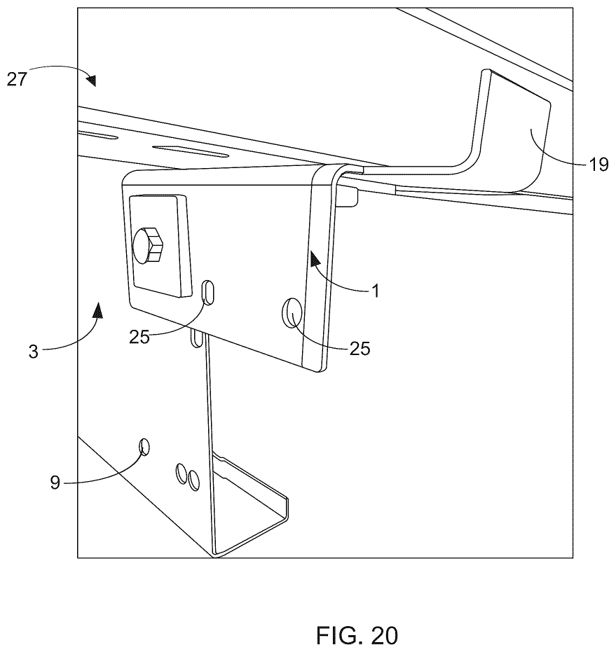

The present disclosure is directed to, in general, a rotatable angle bracket and, in particular, a rotatable angle bracket having an adjustable tilt angle. Certain preferred and non-limiting aspects of the components of the rotatable angle bracket are illustrated in FIGS. 1-20.

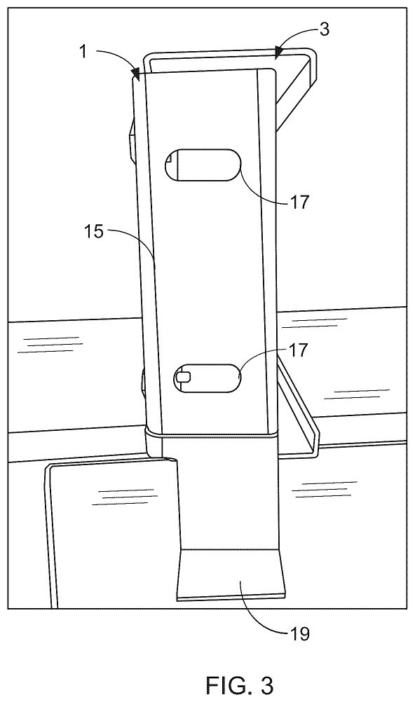

FIG. 1 illustrates a rotatable angle bracket 1, a rafter 3, base member 5 and corresponds to the process of installation and adjustment of the rafter 3 and beams. The rotatable angle bracket 1 includes a number of apertures and slots which allow for the bracket 1 to rotate while being coupled to the rafter 3 to case the installation of the beams. The angle bracket 1 design enables installation crews to utilize a tilting arrangement of a tiltable racking system by unloading beams onto the rafters 3 while in the flat position, positioning the beams (as shown in FIGS. 3-17) on the angle bracket 1 and then rotating the bracket 1 with attached beams into final position for final fastening. The design of the angle bracket 1 with pivot point or apertures and L-shaped slots or apertures enables the bracket 1 to rotate 90 degrees from flat position on top of the rafter 3 to final position. The bracket 1 incorporates a number of safety features. For example, the bent tab 19 at the end of the bracket 1 helps prevent the beam from being pulled off of the end of the bracket 1 when moving the beam from on top of the rafter 3 to its position on the bracket 1.

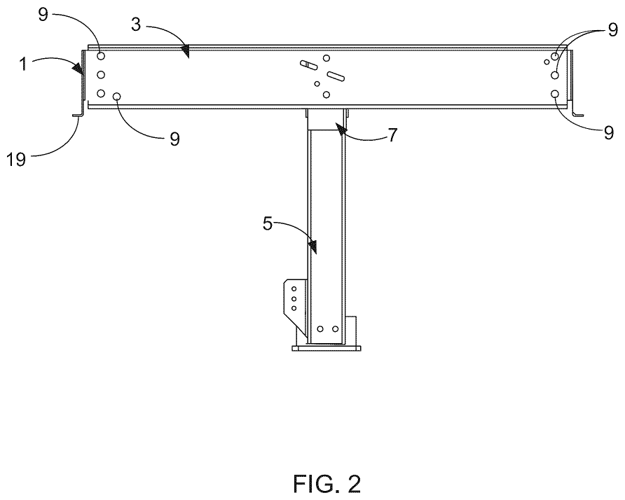

FIGS. 1 and 2 illustrate the rafter 3 coupled to the base member 5. The rafter 3 may be a H-shape geometry, a C-shaped geometry, a W-shaped geometry, a round-shaped geometry, a square-shaped geometry, or a rectangular-shaped geometry capable of coupling or attaching to the rotatable angle bracket 1 and base member 5. The rafter 3 may be coupled or attached to the base member 5 at any point along the rafter 3, but preferably the rafter 3 may be coupled or attached to the base member 5 at the center of gravity of the rafter 3. The center of gravity of the rafter 3 is preferably in the center of the rafter 3. The rafter 3 may include holes, apertures, or any attachment means for coupling or attaching the rafter 3 to the base member 5. An attachment bracket 7 may be used to couple or attach the rafter 3 to the base member 5. The rafter 3 may further include a first end 11 and a second end 13. Each of the ends may include apertures 9 which may couple or attach to the rotatable angle bracket 1. The rotatable angle bracket I can be coupled or connected to one or more ends of the rafter 3, as illustrated in FIGS. 1-3. In some embodiments, each end of the rafters 3 is operatively connected to a respective bracket 1, such that each bracket 1 is configured to connect to beam 27 at each end of the rafter 3.

FIGS. 1 and 2 further illustrate the base member 5. The base member may have a H-shape geometry, a C-shaped geometry, a W-shaped geometry, a round-shaped geometry, a square-shaped geometry, or a rectangular-shaped geometry and be capable of coupling or attaching to the rafter 3. The base member 5 may include holes, apertures, or any attachment means for coupling or attaching to the attachment bracket 7 or to the rafter 3 at a first end. The second end may include an attachment means for fixing to a surface.

FIGS. 1-20 further illustrate the rotatable angle bracket 1. The rotatable angle bracket 1 may couple or attach to either end of the rafter 3. The rotatable angle bracket 1 may include a top surface 15. The top surface 15 may include at least one aperture 17 configured for attaching to a beam. The at least one aperture 17 may be elongated, rounded, or any shape which allows for connecting. The top surface 15 may include a bent tab 19 which extends from the top surface 15. The bent tab 19 may bend at any angle, but preferably a 90 degree angle, in reference to the top surface 15. The top surface 15 may connect to a side surface 21. The side surface 21 may extend from the top surface 15 at any angle, but preferably a 90 degree angle, in reference to the top surface 15. The side surface 21 may include at least one elongated angled aperture 23 and at least one aperture 25. The at least one elongated angled aperture 23 may be any shape, but is preferably L-shaped with a first end and a second end.

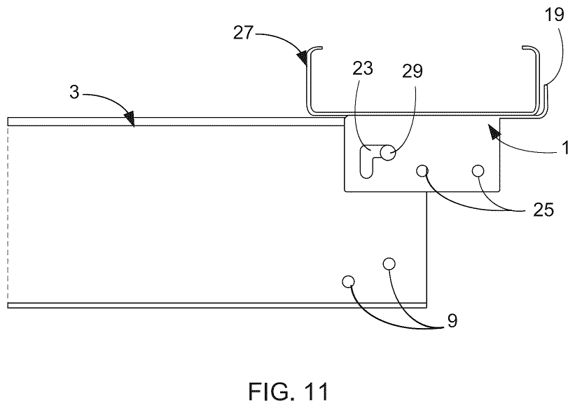

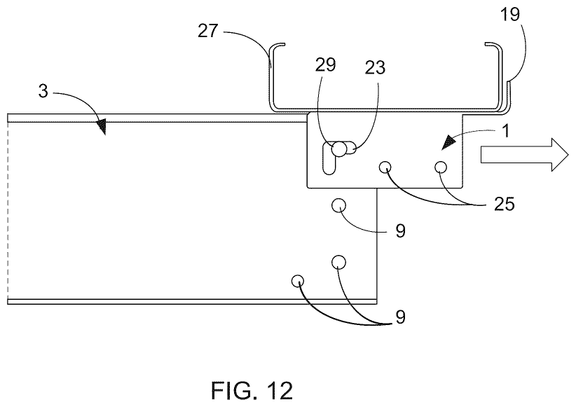

FIG. 11 illustrates the rotatable angle bracket 1 with the rafter 3 in a first state. The first state includes the top surface 15 of the rotatable angle bracket 1 and a top side of the rafter 3 are aligned parallel or along the same plane. This allows for a beam 27 to be coupled or placed on the top surface 15. In the first state the first end of the at least one elongated angled aperture 23 is contacted with a bolt 29. The rotatable angle bracket 1 may rotate around the bolt 29 from the first state to transition to the second state. The rotatable angle bracket 1 may also slide and rotate to transition from the first state to the second state as the at least one elongated angled aperture 23 is shaped to allow for the rotatable angle bracket 1 to slide and rotate, as illustrated in FIGS. 12-17. In the first state the first end of the at least one elongated angled aperture 23 is aligned parallel with the at least two apertures 9 of the rafter 3.

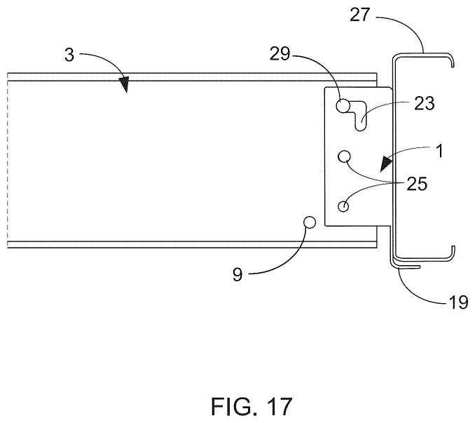

FIG. 17 illustrates the rotatable angle bracket 1 with the rafter 3 in a second state. The second state includes the top surface 15 of the rotatable angle bracket 1 and a top side of the rafter 3 are aligned perpendicular or along perpendicular planes. This allows for a beam 27 to be rotated from the first state to the second state. In the second state the second end of the at least one elongated angled aperture 23 is contacted with the bolt 29. In a second state the second end of the at least one elongated angled aperture 23 is aligned parallel with the at least two apertures 23 of the rafter 3.

As illustrated in FIGS. 1-20, the rotatable angle bracket 1 couples or attaches the beam 27 and installs a system for a photovoltaic module. The rotatable angle bracket 1 may couple to the rafter 3 while in the first state. The beam 27 may then be coupled to the rotatable angle bracket 1 via one of the apertures 17 and the beam 27 may contact the bent tab 19. The rotatable angle bracket 1 may then be slid and rotated or just rotated from the first state to the second state. In the first state, the at least two apertures 9 of the rafter 3 and an axis of the alignment of the at least one apertures 25 are not aligned parallel. In the second state, the at least two apertures 9 of the rafter 3 and an axis of the alignment of the at least one apertures 25 are aligned parallel. In the second state, further bolts may be applied to fix or fasten the rotatable angle bracket 1 to the rafter 3. When transitioning from the first state to the second state, the transition can be prevented or inhibited by the insertion of a bolt 31 which prevents the rotation of the rotatable angle bracket 1. Bolt 31 may be inserted into a cut out 33 or one of the apertures 9. This allows the rotatable angle bracket 1 to be in an intermediate position.

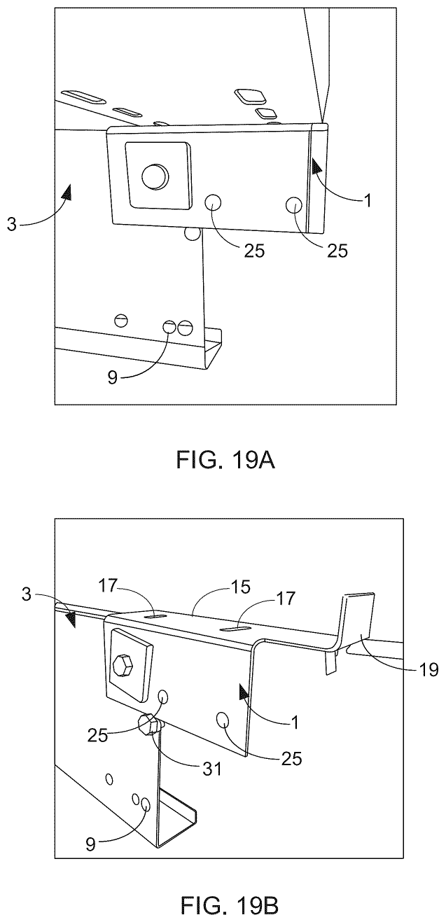

Additionally, a half-circle notch is located below, as shown in FIGS. 19a and 19b for use with a safety bolt when the bracket 1 is in the horizontal position. This half-circle notch will provide a specific location for the bracket 1 to rest on a bolt and prevent the bracket 1 from rotating while the beam is being moved from on top of the rafter 3 to its position on the bracket 1.

Advantageously, the rotatable angle bracket 1 eliminates manual effort lifting racking structure C-shape beams 30 during the assembly of the racking system. This increases the speed of installation of beams on the racking system. Further, the design sets the specific distance between beams. Additionally, this design enables East-West adjustment of beams while accommodating terrain slopes up to 12 degrees.

What is claimed is:

1. A rotatable angle bracket for connecting a fixed tilt photovoltaic module racking system, comprising:
a top surface, the top surface having at least one elongated aperture and a bent tab, the bent tab connected to the top surface at an angle; and
a side surface connected to the top surface at an angle, the side surface having at least one elongated angled aperture aligned with at least one aperture forming an axis, a side of the side surface and the axis are aligned parallel;
wherein the at least one elongated angled aperture has a first end and a second end and the bent tab extends past the side surface.

2. The rotatable angle bracket of claim 1, wherein the angle the bent tab is coupled to the top surface at is approximately 90 degrees.

3. The rotatable angle bracket of claim 1, wherein the angle the top surface is coupled to the side surface is at approximately 90 degrees.

4. The rotatable angle bracket of claim 1, wherein the top surface further comprises a second elongated aperture.

5. The rotatable angle bracket of claim 1, wherein the side surface further comprises at least two apertures.

6. The rotatable angle bracket of claim 1, wherein the side surface further comprises at least one notch.

7. A photovoltaic module racking system, comprising:
a base member, the base member having a first end and a second end;
a rafter coupled to the first end of the base member, the rafter having a first end and a second end and a front surface and a side surface, the first end or second end having at least two apertures; and
a rotatable angle bracket coupled to the first end or second end of the rafter, the rotatable angle bracket comprising:
a top surface, the top surface having at least one elongated aperture and a bent tab, the bent tab connected to the top surface at an angle;
a side surface connected to the top surface at an angle, the side surface having at least one elongated angled aperture aligned with at least one aperture forming an axis, a side of the side surface and the axis are aligned parallel, the at least one elongated angled aperture has a first end and a second end and the bent tab extends past the side surface;
wherein in a first state, the at least two apertures of the rafter and the axis are not aligned parallel, wherein in a second state, the at least two apertures of the rafter and the axis are aligned parallel.

8. The base member of the system of claim 7, wherein the base member is a H-shape geometry, a C-shaped geometry, a W-shaped geometry, a round-shaped geometry, a square-shaped geometry, or a rectangular-shaped geometry.

9. The system of claim 7, wherein the base member and rafter are coupled with an attachment bracket.

10. The system of claim 7, wherein the rafter is coupled to the base member at or near a center of gravity of the rafter.

11. The system of claim 7, wherein the at least one elongated angled aperture of the rotatable angle bracket and at least one aperture of the rafter are aligned and coupled by a bolt such that the rotatable angle bracket rotates about the bolt.

12. The system of claim 7, wherein in the first state the top surface of the rotatable angle bracket and a top side of the rafter are aligned parallel.

13. The system of claim 7, wherein in the second state the top surface of the rotatable angle bracket and a top side of the rafter are aligned perpendicular.

14. The system of claim 7, wherein in the first state the first end of the at least one elongated angled aperture is aligned parallel with the at least two apertures of the rafter and in a second state the second end of the at least one elongated angled aperture is aligned parallel with the at least two apertures of the rafter.

15. A method of installing a system for a photovoltaic module, the method comprising:
coupling a rotatable angle bracket to a rafter in a first state;
the rotatable angle bracket comprising: a top surface, the top surface having at least one elongated aperture and a bent tab, the bent tab connected to the top surface at an angle; a side surface connected to the top surface at an angle, the side surface having at least one elongated angled aperture aligned with at least one aperture forming an axis, a side of the side surface and the axis are aligned parallel; wherein the at least one elongated angled aperture has a first end and a second end and the bent tab extends past the side surface;
the rafter coupled to the first end of the base member, the rafter having a first end and a second end and a front surface and a side surface, the first end or second end having at least two apertures;
coupling a beam to the rotatable angle bracket, the beam comprising at least one aperture; and
rotating the rotatable angle bracket from the first state to a second state, wherein in the first state, the at least two apertures of the rafter and the axis are not aligned parallel, wherein in the second state, the at least two apertures of the rafter and the axis are aligned parallel.

16. The method of claim 5, further comprising: sliding the rotatable angle bracket with the coupled beam from the first state.

17. The method of claim 5, further comprising: fixing the rotatable angle bracket to the coupled beam in the second state.

18. The method of claim 5, further comprising: contacting a first side of the beam with the bent tab.

19. The method of claim 5. further comprising: inserting a bolt in the aperture of the rafter to prevent the rotatable angle bracket from entering the second state.

20. The method of claim 19. further comprising: removing the bolt.
